(19) United States
(12) Patent Application Publication
(10) Pub. No.: US 2007/0103671 A1
(43) Pub. Date: May 10, 2007

(54) Passive-optical locator

(75) Inventor: William M. Ash, Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/268,938

(22) Filed: Nov. 8, 2005

(51) Int. Cl. G01C 1/00; G01C 3/08; G01C 21/00

(52) U.S. Cl. 356/139.01; 356/4.01; 701/223

(57) ABSTRACT

A passive-optical locator including a passive-optical range-finder to generate information indicative of a distance to a target and a sensor to generate information indicative of an azimuth and an elevation of an optical axis of the passive optical range-finder. The passive-optical locator uses information indicative of a geographic location associated with the passive-optical locator, the information indicative of the distance to the target, and the information indicative of the azimuth and the elevation of the optical axis the information to determine information indicative of an absolute geographic location associated with the target.

### BACKGROUND

During some military operations, one or more soldiers locate targets to be fired upon by indirect fire systems or air support (for example) and transmit a geographic location for the target to a fire control center or an integrated tactical network. The fire control center or an integrated tactical network then deploys a strike on the target using the target geographic location. Target designators are used by military personnel to determine the geographical coordinates of a target. One type of target designator is designed so that an operator is able to shine a laser at the target and to receive light scattered and/or reflected from the target in order to determine the geographical coordinates of the target.

However, such lasers are typically detectable by enemy sensors, which detect the laser light and set off alarms. In some cases, once the enemy realizes the target geographic location is being determined, the target is moved and/or hidden and/or hardened. Additionally, the enemy can sometimes trace the optical beam back to the operator of the target designator. In this case, the operator can become a target of the enemy.

Moreover, the divergence of the laser beam used in such target designators limits the range of such target designators. If the range is too large, the spot size of the laser becomes too large for range determination. Thus, the operator must be within 10,000 meters for ranging, and 5000 meters for designation of the target, which can place the operator in tactical danger. Timing, coordination and lethality are of the essence for combined arms operations, particularly for non-organic fire support/air operations. It is highly desirable for the combat team to engage targets at the farthest practical range possible.

Moreover, there are safety issues associated with target designators that use lasers in this way. If the operator or other soldiers near the target designator look directly into the laser, their retina can be burned and/or their vision otherwise impaired.

### SUMMARY

A first aspect of the present invention provides a passive-optical locator including a passive-optical range-finder to generate information indicative of a distance to a target and a sensor to generate information indicative of an azimuth and an elevation of an optical axis of the passive optical range-finder. The passive-optical locator uses information indicative of a geographic location associated with the passive-optical locator, the information indicative of the distance to the target, and the information indicative of the azimuth and the elevation of the optical axis the information to determine information indicative of an absolute geographic location associated with the target.

A second aspect of the present invention provides a method to determine geographic location of a target. The method includes receiving information indicative of a distance between a target and a passive-optical locator, receiving information indicative of an azimuth and an elevation of a direction to the target, receiving information indicative of the geographic location of the passive-optical locator, and generating an absolute geographic location of the target.

A third aspect of the present invention provides a passive-optical locator including a passive-optical range-finder to generate information indicative of a distance to a target and a sensor to generate information indicative of an azimuth and an elevation of an optical axis of the passive optical range-finder and a communication interface. The communication interface communicates at least a portion of: the information indicative of a geographic location associated with the passive-optical locator, the information indicative of the distance to the target, and the information indicative of the azimuth and the elevation of the optical axis to a remote device for processing that generates information indicative of an absolute geographic location associated with the target therefrom.

A fourth aspect of the present invention provides a passive-optical locator, the system including means for receiving information indicative of a distance to a target from a passive-optical locator, means for receiving information indicative of an azimuth and an elevation of a direction to the target, means for receiving information indicative of the geographic location of the passive-optical locator, and means for generating an absolute geographic location of the target.

### DRAWINGS

FIG. 1 is a block diagram of a first embodiment of a system that uses a passive-optical locator.

FIG. 2 is a block diagram of an embodiment of a passive-optical range-finder.

FIG. 3 is a flowchart of one embodiment of a method of determining an absolute geographic location of a target.

FIG. 4 and 5A-5B illustrate the calibration of components of the system of Figure and trigonometric relationships used therein.

FIG. 6 is a block diagram of a second embodiment of a passive-optical locator.

FIG. 7 is a block diagram of a third embodiment of a passive-optical locator.

The various described features are not drawn to scale but are drawn to emphasize features relevant to the subject matter described. Reference characters denote like elements throughout the figures and text.

### DETAILED DESCRIPTION

In the following detailed description, reference is made to the accompanying drawings that form a part hereof, and in which is shown by way of illustration specific illustrative embodiments in which the claimed invention may be practiced. These embodiments are described in sufficient detail to enable those skilled in the art to practice the claimed invention, and it is to be understood that other embodiments may be utilized and that logical, mechanical and electrical changes may be made without departing from the scope of the claimed invention. The following detailed description is, therefore, not to be taken in a limiting sense.

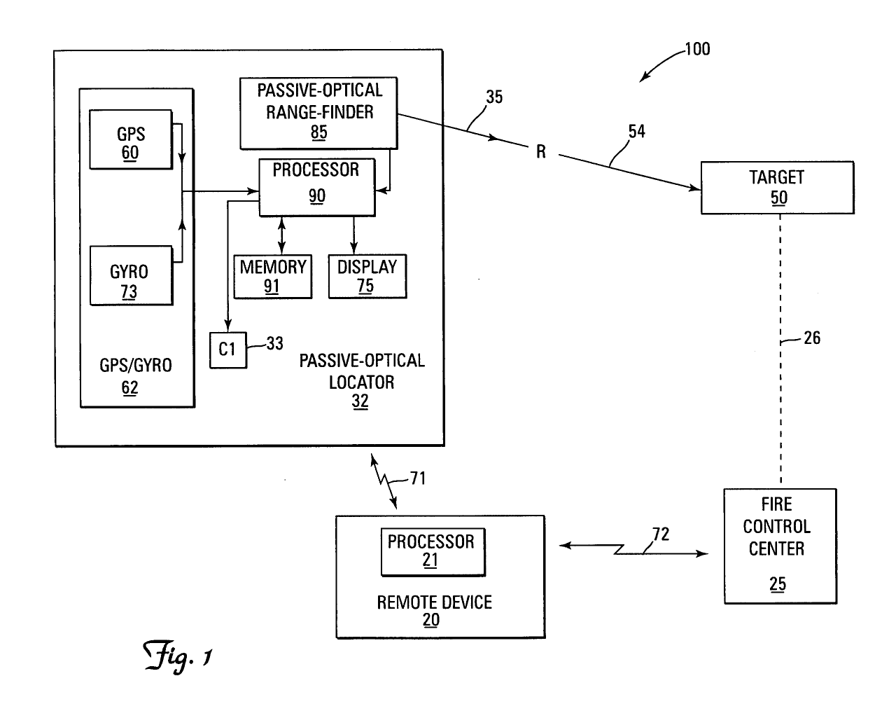

FIG. 1 is a block diagram of a one embodiment of a system 100 that uses a passive-optical locator 32. In the embodiment shown in FIG. 1, the passive-optical locator 32 is deployed in a military application in which the passive-optical locator 32 operates as a laser-free passive-optical locator. The passive-optical locator 32 includes a passive-optical range-finder 85, a global positioning system/gyroscope (GPS/GYRO) device 62, a processor 90, a memory 91, and a display 75. The GPS/GYRO device 62 comprises one or more gyroscopic devices 73 integrated with a global positioning system (GPS) 60. The various components of the passive-optical locator 32 are communicatively coupled to one another as needed using appropriate interfaces (for example, using buses, traces, cables, wires, ports, transceivers and the like).

The processor 90 executes software and/or firmware that causes the processor 90 to perform at least some of the processing described here as being performed by the passive-optical locator 32. At least a portion of such software and/or firmware executed by the processor 90 and any related data structures are stored in memory 91 during execution. Memory 91 comprises any suitable memory now known or later developed such as, for example, random access memory (RAM), read only memory (ROM), and/or registers within the processor 90. In one implementation, the processor 90 comprises a microprocessor or microcontroller. Moreover, although the processor 90 and memory 91 are shown as separate elements in FIG. 1, in one implementation, the processor 90 and memory 91 are implemented in a single device (for example, a single integrated-circuit device). The software and/or firmware executed by the processor 90 comprises a plurality of program instructions that are stored or otherwise embodied on a storage medium (not shown in FIG. 1) from which at least a portion of such program instructions are read for execution by the processor 90. In one implementation, the processor 90 comprises processor support chips and/or system support chips such as ASICs.

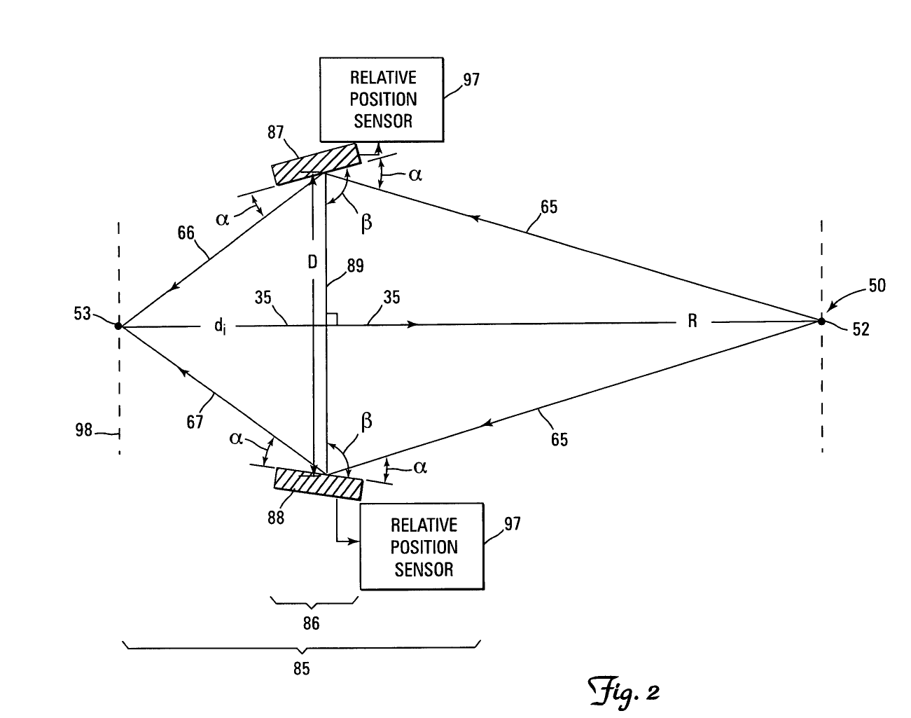

The passive-optical range-finder 85 generates information indicative of a distance R from the passive-optical locator 32 to a target 50. This information is also referred to here as “distance information.” The passive-optical range-finder 85 generates the distance in a passive optical manner in which the target 50 is not illuminated with a laser. The passive-optical range-finder 85, in one implementation of the embodiment shown in FIG. 1, comprises an image-coincidence range finder of the type shown in FIG. 2. In other embodiments, the passive-optical range-finder 85 is implemented in other ways, for example, using a passive auto-ranging range-finder, a tilted image plane sensor range-finder, a depth-of-focus range-finder, Charged Coupled Devices (CCD), Active Pixel Sensors (APS), and night vision capability with technologies like an infra-red imaging viewer, or a light intensification imaging viewer. One example of a commercially available passive-optical image coincidence range-finder is the Commercial-Off-The-Shelf (COTS) RANGING 200 rangefinder, which is available from CABELAS. One example of an infra-red imaging viewer is the COTS T14FLIR THERMAL IMAGING HAND HELD VIEWER-GOGGLE AND WEAPON SIGHT, which is available from Imaging1.com. In one implementation, the distance information generated by the passive-optical range-finder 85 is used to generate a distance between the passive-optical locator 32 and the target 50. The designation, ranging and range accuracy are limited by the quality and capability of the optics and the accuracy of the coordinate system and its transforms. As used herein, the passive-optical range-finder 85 is referred to as being “focused” or “in focus” when the passive-optical range-finder 85 is optically configured or otherwise adjusted so as to measure properly the distance between the passive-optical range-finder 85 and the target 50.

The one or more gyroscopic devices 73 in the GPS/GYRO device 62 generate information indicative of an azimuth θ and an elevation φ of an optical axis 35 of the passive-optical range-finder 85. Such information is also referred to here as “azimuth and elevation information.” In FIG. 1, only one such gyroscopic device 73 is shown though it is to be understood that one or more gyroscopic devices 73 are used in various implementations of such an embodiment. In one implementation of such an embodiment, gyroscopic device 73 comprises an inertial navigation system that generates the azimuth and elevation information.

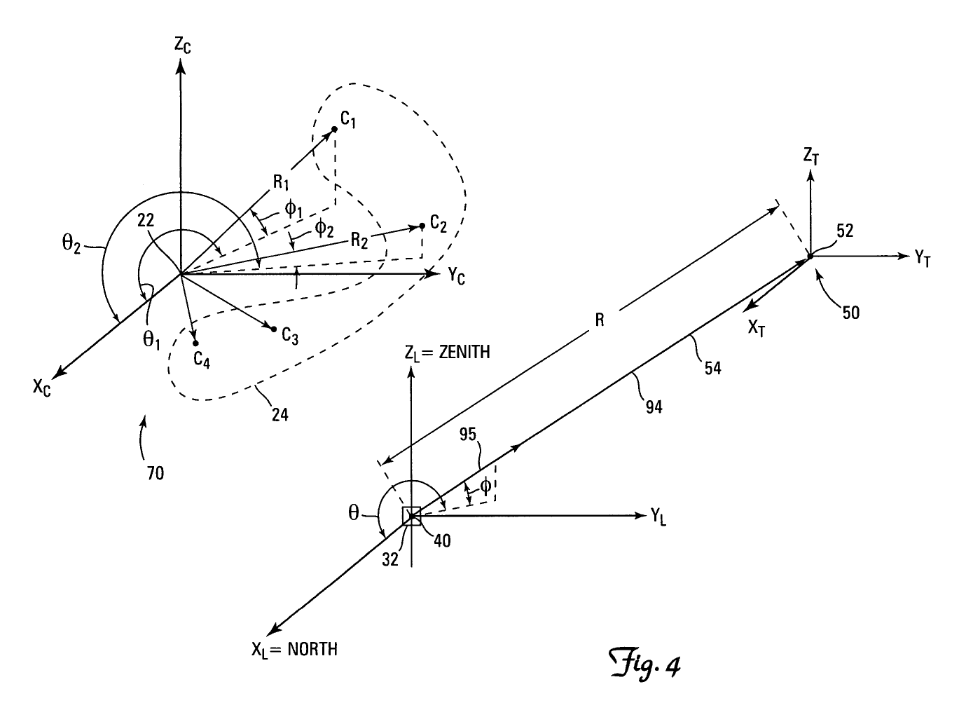

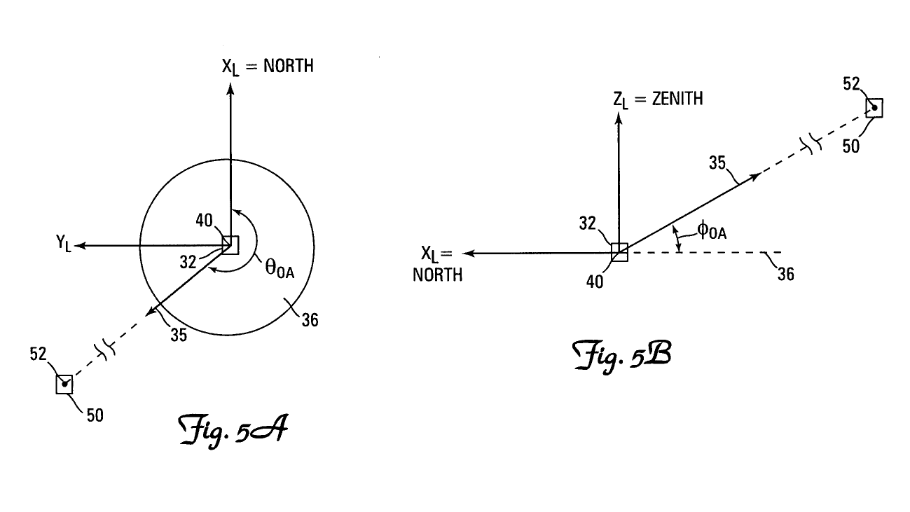

The GPS 60 in the GPS/GYRO device 62 generates or otherwise outputs information indicative of an absolute geographic location associated with the passive-optical locator 32. Such information is also referred to here as “GPS information.” In one implementation of such an embodiment, the GPS information associated with the passive-optical locator 32 includes the latitude Lat_{L}, the longitude Long_{L}, and the attitude Alt_{L} of the passive-optical locator 32. The GPS 60 includes various GPS implementations such as Differential GPS (DGPS). Although the gyroscopic device 73 and the GPS 60 are shown in FIG. 1 as a single, integrated device, in other implementations the GPS 60 and the gyroscopic device 73 are implemented using two more separate devices. The software and/or firmware executing on the processor 90 processes the GPS information, the distance information, and the azimuth and elevation information in order to determine information indicative of an absolute geographic location associated with the target 50 (also referred to here as the “target location information”). The target location information is defined by a latitude Lat_{T}, a longitude Long_{T}, and a altitude Alt_{T} of the target 50 and is generated using one or more trigonometric relationships between the distance between the passive-optical range-finder 85 and the target 50, the azimuth θ and the elevation φ of the optical axis 35 of the passive-optical range-finder 85, and the absolute geographic location of the passive-optical locator 32. In one implementation, such trigonometric relationships are established and/or corrected using the calibration techniques described below in connection with FIGS. 4 and 5A-5B. In one implementation of the embodiment of the passive-optical locator 32 of FIG. 1, the processor 90 outputs the target location information associated with the target 50 on the display 75. The display 75 provides a visual indication of the absolute location of the target 50 for the operator of the passive-optical locator 32. In one implementation of such an embodiment, the display 75 shows the values for the target latitude Lat_{T}, target longitude Long_{T} and target altitude Alt_{T}. In another implementation, the display 75 shows the values for the azimuth θ and the elevation φ from the passive-optical locator 32, as well as, the target latitude Lat_{T}, a target longitude Long_{T} and a target altitude Alt_{T}. In other implementations, information indicative of the absolute location of the target 50 is displayed in other ways.

In the embodiment shown in FIG. 1, the passive-optical locator 32 comprises a communication interface (CI) 33 that communicates at least a portion of the information indicative of the absolute location of the target 50 from the passive-optical locator 32 to a remote device 20 over a communication link 71. The communication link 71 comprises one or more of a wireless communication link (for example, a radio-frequency (RF) communication link) and/or a wired communication link (for example, an optical fiber or copper wire communication link). For applications of such an embodiment in which secure communication is desired, one or more appropriate protocols for automation, encryption, frequency hopping, and spread-spectrum concealment are used in communicating such information from the passive-optical locator 32 and the remote device 20. In one implementation of such an embodiment, the target location information is communicated from the passive-optical locator 32 to the remote device 20 by having the operator read such the target location information off the display 75 and describe the target (for example, “Dismounted troops in the open at this grid coordinate”). The operator announces the target location information and the target description into a microphone coupled to the communication interface 33 so that the voice of the operator is communicated over the communication link 71 to the remote device 20. In another implementation, the target location information is communicated in digital form from the processor 90 over the communication link 71. In such an implementation, a processor 21 included in the remote device 20 executes software to process such target location information.

In an alternative embodiment, the target location information is not generated at the passive-optical locator 32 and, instead, the distance information, azimuth and elevation information, and GPS information is communicated from the passive-optical locator 32 to the remote device 20 and the remote device 20 generates the absolute geographic location associated with the target 50 using such distance information, azimuth and elevation information, and GPS information (for example, using software executing on the processor 21 of the remote device 20).

In the embodiment shown in FIG. 1, the remote device 20 is part of an integrated tactical network. The integrated tactical network comprises a wide area network (WAN) used for communications, command, control and intelligence functions for military operations. The integrated tactical network integrates the indirect fire control centers and forward air controllers to direct fire missions and air strikes. As shown in FIG. 1, the remote device 20 is part of an integrated tactical network. The remote device 20 communicates the target location information for the target 50 to a fire control center 25 over a communication link 72. A target description is also communicated. The fire control center 25 is operable to deploy a weapon (not shown) on a trajectory 26 towards the target 50. In one implementation, the passive-optical locator 32 is packaged in a bipod/shoulder unit that can be carried by a soldier. In another implementation, the passive-optical locator 32 is packaged in a tripod unit that can be carried by a soldier. In yet another implementation, the passive-optical locator 32 is mounted on a vehicle.

The communication link 72 comprises one or more of a wireless communication link (for example, a radio-frequency (RF) communication link) and/or a wired communication link (for example, an optical fiber or copper wire communication link). For applications of such an embodiment in which secure communication is desired, one or more appropriate protocols for automation, encryption, frequency hopping, and spread-spectrum concealment are used in communicating such information from the remote device 20 to the fire control center 25.

Although a military application is described here in connection with FIG. 1, it is to be understood that the passive-optical locator 32 can be used in other applications, including commercial applications. Generally, the target 50 is an object to be located at an absolute geographic location. In one exemplary usage scenario, the object to be located is a person stranded on a side of a mountain. In this usage scenario, a person in a search and rescue party uses the passive-optical range-finder 85 of the passive-optical locator 32 to focus on an image of the stranded person and the target location information of the stranded person is communicated to a rescue helicopter. Other applications include geographical surveying, civil engineering and navigation.

FIG. 2 is a block diagram of one embodiment of a passive-optical range-finder 85. The embodiment of the passive-optical range-finder 85 shown in FIG. 2 is described here as being used in the system 100 of FIG. 1 (though it is to be understood that the passive-optical range-finder 85 can be used in other embodiments).

The particular embodiment of the passive-optical range-finder 85 shown in FIG. 2 comprises an implementation of an image-coincidence range finder. The passive-optical range-finder 85 comprises focusing optics (not shown) and relative components 86. In this embodiment, the relative components 86 include a self contained base 89, a first mirror 87 and a second mirror 88. The first mirror 87 and the second mirror 88 are at opposing ends of the self contained base 89. While passive optical range-finder 85 is focused, the first mirror 87 and the second mirror 88 are rotated. The rotation is about a vertical axis formed at the point where the first mirror 87 and the second mirror 88 intersect with the self contained base 89. A mechanical adjustment system (not shown) is operable to ensure that angle β between the first mirror 87 and the self contained base 89 always equals the angle β between the second mirror 88 and the self contained base 89.

When the focusing optics of the passive-optical range-finder 85 focus the light 65 that is reflected, emitted and/or scattered from the target 50, the first mirror 87 and the second mirror 88 each reflect at least a portion of the light 65. The first mirror 87 reflects light 65 as light 66 towards the focal plane 98 of the passive-optical range-finder 85. The second mirror 88 reflects light 65 as light 67 towards the focal plane 98 of the passive-optical range-finder 85. The angle of incidence of the light 65 is 90°−α for both the first mirror 87 and the second mirror 88, where α is the angle formed between the first mirror 87 and the light 66 and the second mirror 88 and the light 67. As the image 53 of the target 50 is focused in the focal plane 98, the first mirror 87 and the second mirror 88 are rotated into the angular position in which the light 66 is coincident with light 67 in the focal plane 98. When target 50 is “focused” (also referred to here as being “in focus”) in the focal plane 98, the target image 53 from light 66 is coincident with the target image 53 from light 67.

One or more relative-position sensors 97 in the passive-optical range-finder 85 generate relative-position sensor data about the relative angle β between the self contained base 89 and the first mirror 87 and the second mirror 88. When the target 50 is focused, the relative-position sensor data about the relative angle β is output by the passive-optical range-finder 85 to the processor 90 (shown in FIG. 1). In such an embodiment, the software and/or firmware executing on the processor 90 generates calculates the distance between the passive-optical range-finder 85 and the target 50 using one or more trigonometric relationships between the length of the self contained base 89 and the relative angle β between the self contained base 89 and the first mirror 87 and the second mirror 88. In one implementation, such trigonometric relationships are established and/or corrected using the calibration techniques described below in connection with FIGS. 4 and 5A-5B. In other embodiments, the passive-optical range-finder 85 comprises a separate, integrated processor that performs the trigonometric and/or calibration processing and outputs data that encodes or otherwise contains the distance between the passive-optical range-finder 85 and the target 50.

In military or self-contained-base rangefinders, the first mirror 87 and the second mirror 88 are penta-prisms or penta-mirrors and only one of the first mirror 87 and the second mirror 88 rotates so that the two images from the first mirror 87 and the second mirror 88 overlap. An implementation of a self-contained-base rangefinder is described in pages in pages 238-242 of “Optical System Design,” written by Rudolf Kingslake and published in 1983 by Academic Press, Inc.

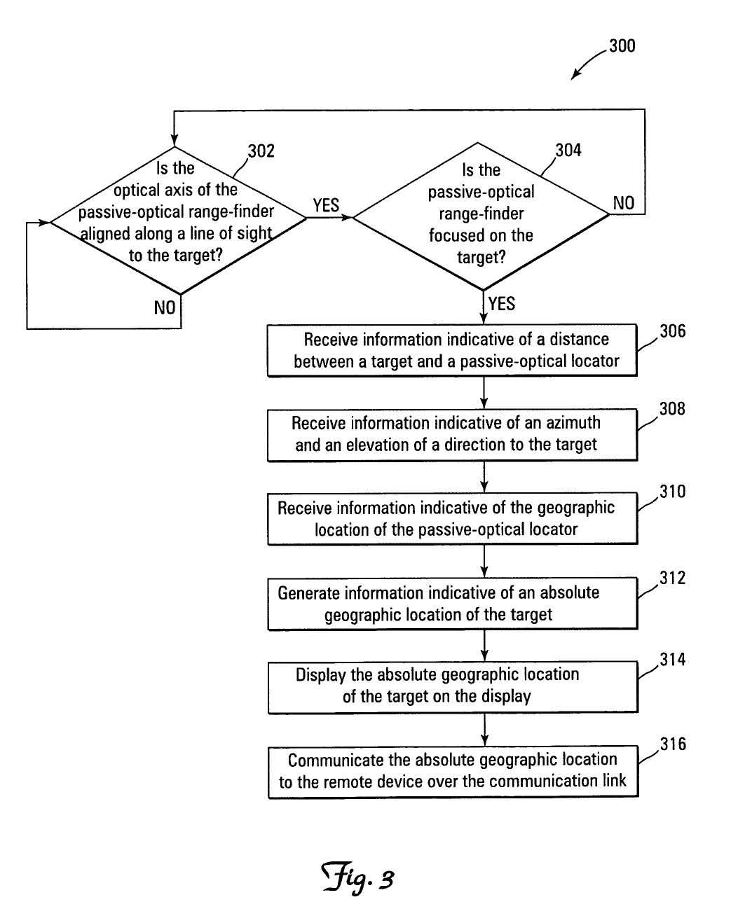

FIG. 3 is a flowchart of one embodiment of a method 300 of determining an absolute geographic location of a target. The embodiment of method 300 is described as being implemented using the passive-optical locator 32 of FIG. 1. In such an embodiment, at least a portion of the processing of method 300 is performed by software executing on the processor 90 of the passive-optical locator 32 and/or the GPS/GYRO device 62 or the passive-optical range-finder 85.

When an operator of the passive-optical range-finder 85 has aligned the optical axis 35 of the passive-optical range-finder 85 along a line of sight 54 to the target 50 (checked in block 302) and the operator has focused the passive-optical range-finder 85 (checked in block 304), the information indicative of the distance between the passive-optical locator 32 and the target 50 (that is, the distance information) is generated (block 306). For example, in one implementation, the passive-optical locator 32 comprises a button or other switch that the operator actuates in order to signal to software executing on the processor 90 that the operator has aligned the optical axis 35 of the passive-optical range-finder 85 along a line of sight 54 to the target 50 and has focused the passive-optical range-finder 85. When this happens, the passive-optical range-finder 85 generates the distance information (for example, as described above in connection with FIG. 2) and outputs such distance information to the software executing on the processor 90.

Software executing on the processor 90 then receives information indicative of an azimuth θ and an elevation φ of an optical axis 35 of the passive-optical range-finder 85 and information indicative of the absolute geographic location of the passive-optical locator 32 from the GPS/GYRO device 60 (blocks 308 and 310). The software executing on the processor 90 then uses one or more trigonometric relationships between the distance between the passive-optical range-finder 85 and the target 50, the azimuth θ θ and the elevation φ of the optical axis 35 of the passive-optical range-finder 85, and the absolute geographic location of the passive-optical locator 32 to generate information indicative of an absolute geographic location of the target 50 (block 312). The software executing on the processor 90 of the passive-optical locator 32 then displays the absolute geographic location of the target 50 on the display 75 (block 314) and/or communicates the absolute geographic location to the remote device 20 over the communication link 71 (block 316).

In order for the distance information about the target 50 to be accurate, the passive optical range-finder 85 must be calibrated. In order for the azimuth and elevation information to be accurate, the gyroscopic device 73 must be calibrated. Likewise, in order for the GPS information to be accurate, the global positioning system 60 must be calibrated. FIG. 3 illustrates one approach to calibrating the global positioning system 60, the gyroscopic device 73, and the passive-optical range-finder 85 of FIG. 1 that makes use of the image-coincidence range finder shown in FIG. 2. When the global positioning system 60, the gyroscopic device 73, and the passive-optical range-finder 85 are all calibrated, the passive-optical locator 32 is operable to determine accurately an azimuth θ θ, an elevation φ and a distance R to a target 50 when the target 50 is focused on an image plane 98 (shown in FIG. 2) of the passive-optical locator 32. Then the processor 90 accurately determines the absolute location information for the target geographic location 52 of a target 50.

A calibration benchmark 70 is positioned at a calibration geographic location 22 defined by a benchmark latitude Lat_{BM}, benchmark longitude Long_{BM}, and benchmark altitude Alt_{BM}. The calibration geographic location 22 is at the origin of the coordinate system defined by the vectors X_{c}, Y_{c}, and Z_{c}. In the field, the passive-optical locator 32 is located at geographic location 40 defined by a passive-optical locator latitude Lat_{L}, passive-optical locator longitude Long_{L}, and passive-optical locator attitude Alt_{L}. The geographic location 40 is at the origin of the coordinate system defined by the vectors X_{L}, Y_{L}, and Z_{L}.

As defined herein, altitude is the height above or below sea level where a positive altitude is above sea level. As defined herein, elevation φ is the angle subtended by a line, such as unit vector 95, and a locally absolute horizon in the plane defined by X_{L} and Y_{L}. The tail of unit vector 95 is at the origin of the coordinate system defined by the vectors X_{L}, Y_{L}, and Z_{L} and unit vector 95 points toward the target 50 positioned at the absolute target geographic location 52. Unit vector 95 is equal in direction to range vector 94. Range vector 94 has the length R equal to the distance between the passive-optical locator 32 and the target 50.

The locally absolute horizon at a given geographic location includes the points in the plane tangential to the earth's surface as the distance away from the geographic location becomes much larger than other dimensions under consideration as shown in FIGS. 5A and 5B. Except for the special cases when the geographic location is at one of the earth's poles, the locally absolute horizon contains the cardinal direction vectors north, south, east and west. The zenith and nadir of the geographic location are perpendicular to this tangential plane, the zenith being directly above the given geographic location and the nadir being directly below the given geographic location.

In accordance with one implementation of the passive-optical locator 32, FIGS. 5A and 5B are a top view and a side view, respectively, of the azimuth θ, elevation φ to the target 50 from the passive optical range-finder 32 with respect the locally absolute horizon 36.

In FIG. 5A, the top view of the passive-optical locator 32 shows the locally absolute horizon 36 in the plane defined by X_{L} and Y_{L}. The passive-optical locator 32 is located at the geographic location 40 where X_{L} and Y_{L} intersect and optical axis 35 is pointed towards the target 50. The azimuth θ is defined as the angle subtended by the north direction and a line on the locally absolute horizon. A 90° azimuth is the east direction, and a 270° azimuth is the west direction. In FIG. 5A, the optical axis 35 is seen projected onto the locally absolute horizon 36 and the azimuth θ is about 225°.

In FIG. 5B, the side-view of the passive-optical locator 32 shows the cross-sectional view of the locally absolute horizon 36. The optical axis 35 is seen at an elevation φ of about 45° from the locally absolute horizon 36. The zenith of the passive-optical locator 32 is defined by Z_{L}.

As shown FIG. 4, the azimuth θ is between the north direction X_{L} and a line that is the projection of vector 95 onto the plane defined by X_{L}-Y_{L}. The line of sight 54 is along the vector 94 shown connecting the geographic location 40 to the target geographic location 50. The geographic location 40 is a distance R from the target geographic location 50. Thus as illustrated, the target 50 is at an azimuth θ, an elevation φ and a distance R from the passive-optical locator 32.

The calibration benchmark 70 includes a graduated range 24, which includes an exemplary plurality of calibration targets C₁, C₂, C₃ and C_{4(. . . )}. More than four calibrations targets are typically implemented in a calibration benchmark. Calibration targets C₁, C₂, C₃ and C₄ provide reference points from the calibration geographic location 22. Each calibration target C₁, C₂, C₃ and C₄ is at a known distance, a known azimuth and a known elevation from the calibration geographic location 22. In one implementation of the calibration process of the passive-optical locator 32, the passive-optical locator 32 is positioned at the calibration geographic location 22 and sequentially aimed at each of the calibration targets C₁, C₂, C₃ and C₄.

While the passive-optical locator 32 is located at the calibration geographic location 22 and the passive-optical range-finder 85 is focused on the calibration target C1, information is obtained for correlation with the reference point of calibration target C1. The obtained information includes: distance information about calibration target C1; azimuth and elevation information about calibration target C1 which includes azimuth and elevation information about the optical axis 35 when the passive-optical range-finder 85 is focused on target C1; and information indicative of the geographic location of the passive-optical locator 32.

When focused on the calibration target C1, the passive-optical range-finder 85 generates distance information about calibration target C1. The gyroscopic device 73 generates the azimuth and elevation information about calibration target C1. The global positioning system 60 generates GPS information for the passive-optical locator 32. If the generated information indicates the known distance r₁ to the calibration target C1, the known azimuth θ₁,of the calibration target C1, the known elevation φ₁, of calibration target C1, and the benchmark latitude Lat_{BM}, benchmark longitude Long_{BM}, and benchmark altitude Alt_{BM} of the calibration geographic location 22, the passive-optical locator 32 is calibrated for that calibration target C1.

In one implementation of the calibration process, during the next stage of calibration, the passive-optical range-finder 85 is focused on the calibration target C2. The obtained information then includes: distance information about calibration target C2; azimuth and elevation information about calibration target C2 which includes a azimuth and elevation information about the optical axis 35 when the passive-optical range-finder 85 is focused on target C2. The information indicative of the geographic location of the passive-optical locator 32 has not changed since the passive-optical locator 32 has not moved from the calibration geographic location 22.

When focused on the calibration target C2, the passive-optical range-finder 85 generates the distance information about calibration target C2. The gyroscopic device 73 generates azimuth and elevation information about calibration target C2. If the respective information indicates the known distance r₂ to the calibration target C2, the known azimuth θ₂ of the calibration target C2, and the known elevation φ₂ of calibration target C2 the passive-optical locator 32 is calibrated to the second calibration target C2. In one implementation of the calibration process, during the next stage of calibration, the passive-optical range-finder is focused on the calibration target C3. The process is repeated for all the remaining calibration targets C3-C4. If there are no differences between the known and measured distances, azimuths and elevations and geographic locations, the passive-optical locator 32 is calibrated.

When the passive-optical range-finder 85 is calibrated with the calibration benchmark 70 and is focused on the target 50, the passive optical range-finder 85 generates accurate distance information for the target 50.

When the global positioning system 60 is calibrated with the calibration benchmark 20, the global positioning system 60 generates accurate GPS information indicative of a passive-optical locator latitude Lat_{L}, a passive-optical locator longitude Long_{L} and a passive-optical locator altitude Alt_{L} for any position of the passive-optical locator 32. Global positioning systems are known by those of skill in the art and are not described herein.

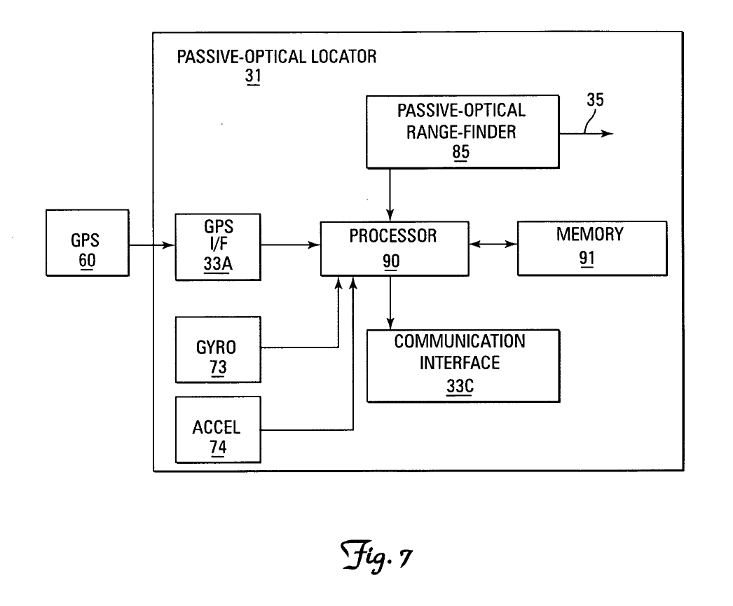

When the gyroscopic device 73 is calibrated with the calibration benchmark 20 and co-located with the global positioning system 60, the gyroscopic device 73 generates accurate azimuth and elevation information for the optical axis 35. The azimuth and elevation information includes an optical axis azimuth θ_{OA} and an optical axis elevation φ_{OA} (FIGS. 5A and 5B). The elevation φ_{OA} can be negative or positive. Inertial navigation systems are known by those of skill in the art and are not described herein. In one implementation of the passive-optical locator, the gyroscopic device 73 in the passive-optical locator 32 recognizes, tracks and stores all movements of the passive-optical locator subsequent to the calibration process as the passive-optical locator is transported to other geographic locations. This information may be stored with the gyroscopic device 73 or downloaded into the integrated tactical network for maintenance record keeping. In one implementation of such an embodiment of a gyroscopic device 73, the gyroscopic device 73 includes an accelerometer 74 (FIG. 7).

In another implementation of the passive-optical range-finder 85, the global positioning system 60, the gyroscopic device 73, and the passive-optical range-finder 85 are calibrated when they are manufactured and the calibration is maintained by the manufacturer of each of the global positioning system 60, the gyroscopic device 73, and the passive-optical range-finder 85.

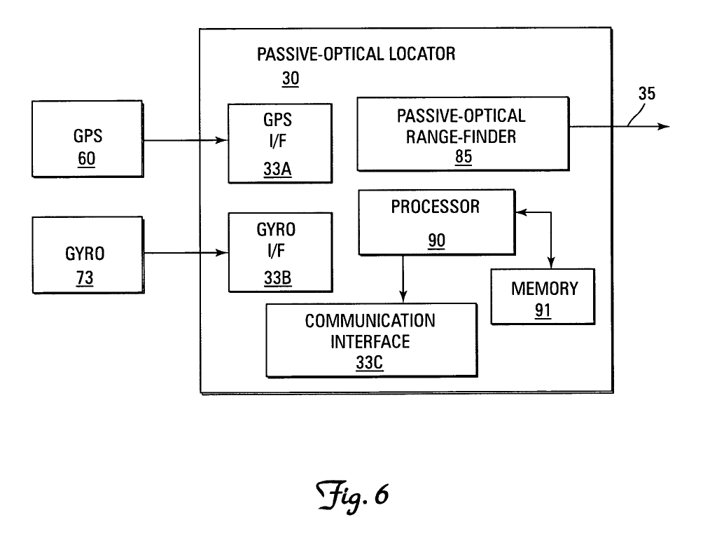

FIG. 6 is a block diagram of a second embodiment of a passive-optical locator 30. In the embodiment shown in FIG. 6, the global positioning system 60 and one or more gyroscopic devices 73 are located external to the passive-optical locator 30. The passive-optical locator 30 includes a passive-optical range-finder 85, a processor 90, memory 91, a GPS interface 33A, a gryo interface 33B and a communication interface 33C. In FIG. 6, only one such gyroscopic device 73 is shown though it is to be understood that one or more gyroscopic devices 73 are used in various implementation of such an embodiment. In this implementation of the passive-optical locator 30, the one or more gyroscopic devices 73 located external to the passive-optical locator 30 are physically attached to the passive-optical locator 30 and the one or more gyroscopic devices 73 are each calibrated for alignment to the optical axis 35 of the passive-optical range-finder 85 before the passive-optical locator 30 is implemented.

The global positioning system 60 communicates with the passive-optical locator 30 via the GPS interface 33A. The GPS interface 33A communicates data from the global positioning system 60 to the processor 90. The one or more gyroscopic devices 73 communicate with the passive-optical locator 30 via gyro interface 33B. The gyro interface 33B communicates data from the one or more gyroscopic devices 73 to the processor 90. The passive-optical locator 30 in conjunction with the externally-located global positioning system 60 and one or more gyroscopic devices 73 attached to the passive-optical locator 30 performs the same functions as the passive-optical locator 32 of FIG. 1.

The various components of the passive-optical locator 30 are communicatively coupled to one another as needed using appropriate interfaces (for example, using buses, traces, cables, wires, ports, and the like). In one implementation of the embodiment shown in FIG. 6, the GPS interface 33A, the gyro interface 33B and the communication interface 33C comprise one communication interface. Other implementations of such an embodiment are implemented in other ways. In one implementation of the embodiment shown in FIG. 6, the one or more gyroscopic devices 73 are strapped onto an aiming barrel of the passive-optical locator 30 prior to a calibration alignment of the one or more gyroscopic devices 73 to the optical axis 35.

FIG. 7 is a block diagram of a third embodiment of a passive-optical locator 31. In this embodiment of the passive-optical locator 31, the one or more gyroscopic devices 73 are co-located with one or more accelerometers 74 in the passive-optical locator 31 and the global positioning system 60 is external to the passive-optical locator 31. The global positioning system 60 is communicatively coupled to the rest of the passive-optical locator 31 via a GPS interface 33A. The one or more accelerometers 74 are communicatively coupled to the processor 90.

The one or more accelerometers 74 are operable to sense linear motion of the passive-optical locator 31. The one or more accelerometers 74 are also operable to monitor for shock or vibrations of the passive-optical locator 31 that could negatively impact the operation of the passive-optical locator 31. In one implementation of the passive-optical locator 31, the processor 90 transmits a warning to the operator if the one or more accelerometers 74 sense a potentially damaging impact on the passive-optical locator 31. In another implementation of the passive-optical locator 31, the operator of the passive-optical locator 31 carries the global positioning system 60 in a backpack while operating the passive-optical locator 31. The passive-optical locator 31 in conjunction with the externally-located global positioning system 60 performs the same functions as the passive-optical locator 32 of FIG. 1.

Other methods of range-finding are operable with the various passive-optical locators 30, 31 and 32. In one implementation of the passive-optical locator, the range-finder includes an imaging devices such as charge-coupled-devices (CCD) or active pixel sensors (APS). In such an implementation, the CCD or APS images the target 50, the processor 90 receives data from the CCD and processes the data to determine the apparent size of the target 50 at the specific magnification of the passive-optical locator. Then the processor 90 searches databases of sized-images stored in memory 91 and determines if a dimensional fit correlates with the image sensed at the CCD. If there is a fit, the processor 90 provides the distance R to the target 50 to the operator of the passive-optical locator.

Both APS and CCD technologies input entire frame images to processing electronics so the process is very fast. The operator views the image of the Field-Of-View (FOV) in the display 75 (FIG. 1). In this implementation, the target 50 is not necessarily an object, but may be a Field-Of-View that can be focused upon. An automated routine would search for the sharpest pixel delineation.

Available detectors arrays in CCDs and APSs are capable of detecting a broadband spectrum including visible light, the near infrared (NIR), and near ultraviolet. In one implementation of this embodiment, the passive-optical locator includes a plurality of detector arrays that in combination cover all of the above spectral ranges. CCD detectors include Intensified CCD (ICCD), Electron Multiplying CCD (EMCCD), and other associated technologies, such as light intensification and infra-red imagery. Light intensification and infra-red imagery allow for night vision.

The automated imaging function provided by imaging devices allows for integration of the passive-optical locator in a robotic system. A robotic system that includes a passive-optical locator is capable of indirect fire and air control, forward observation/spotting and optical surveillance for robotic maneuver teams, long-term staring forward observation/spotting for indirect fire and air control and optical surveillance missions.

One implementation of the passive-optical locator includes a warning capabiliy to warn the operator, the fire control center and/or the integrated tactical network if the passive-optical locator has sent or is ready to send a fire request that will provide an impact that endangers the location of the passive-optical locator.

The various components of the passive-optical locator 31 are communicatively coupled to one another as needed using appropriate interfaces (for example, using buses, traces, cables, wires, ports, transceivers and the like). In one implementation of the embodiment shown in FIG. 7, the GPS interface 33A and the communication interface 33C comprise one communication interface. Other implementations of such an embodiment are implemented in other ways.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A passive-optical locator comprising:
a passive-optical range-finder to generate information indicative of a distance to a target; and
a sensor to generate information indicative of an azimuth and an elevation of an optical axis of the passive optical range-finder, wherein the passive-optical locator uses information indicative of a geographic location associated with the passive-optical locator, the information indicative of the distance to the target, and the information indicative of the azimuth and the elevation of the optical axis the information to determine information indicative of an absolute geographic location associated with the target.

2. The passive-optical locator of claim 1, further comprising;
a global positioning system to generate the information indicative of a geographic location associated with the passive-optical locator.

3. The passive-optical locator of claim 2, wherein the global positioning system is co-located with the passive-optical range-finder.

4. The passive-optical locator of claim 2, wherein the global positioning system is co-located with passive-optical range-finder and the sensor.

5. The passive-optical locator of claim 1, wherein the sensor is a gyroscopic device.

6. The passive-optical locator of claim 5, wherein the gyroscopic device is co-located with the passive-optical range-finder.

7. The passive-optical locator of claim 5, further comprising:
an accelerometer co-located with the gyroscopic device.

8. The passive-optical locator of claim 1, further comprising:
a processor operable to determine the information indicative of an absolute geographic location associated with the target.

9. The passive-optical locator of claim 8, wherein the determined information is transmitted to a remote device.

10. The passive-optical locator of claim 8, wherein the processor is located in the remote device.

11. The passive-optical locator of claim 8, wherein the processor is co-located with the passive-optical range-finder.

12. The passive-optical locator of claim 1, further comprising:
a display operable to visually indicate information indicative of an absolute geographic location associated with the target.

13. The passive-optical locator of claim 1, wherein the sensor includes an inertial navigation system.

14. The passive-optical locator of claim 1, wherein the passive-optical range-finder includes at least one of a passive auto-ranging range-finder, a tilted image plane sensor range-finder, an image coincidence range-finder, a depth-of-focus range-finder, infra-red imaging range-finder, and a light intensification range-finder.

15. A method to determine geographic location of a target, the method comprising:
receiving information indicative of a distance between a target and a passive-optical locator;
receiving information indicative of an azimuth and an elevation of a direction to the target;
receiving information indicative of the geographic location of the passive-optical locator; and
generating an absolute geographic location of the target.

16. The method of claim 15, wherein receiving information indicative of a distance between a target and a passive-optical locator comprises:
aligning the optical axis of the passive-optical range-finder along a line of sight to the target;
focusing the target at an image plane of the passive optical range-finder;
sensing relative positions of components in the passive optical range-finder; and
generating information indicative of the distance based on the relative positions.

17. The method of claim 16, wherein receiving information indicative of an azimuth and an elevation of a direction to the target comprises:
generating information indicative of the azimuth of the optical axis and the elevation of the optical axis with respect to a locally absolute horizon while focusing the target on an image plane of the passive optical range-finder.

18. The method of claim 17, wherein the generating an absolute geographic location of the target comprises:
generating information indicative of a vector from the information indicative of a distance an azimuth and an elevation.

19. A passive-optical locator comprising:
a passive-optical range-finder to generate information indicative of a distance to a target; and
a sensor to generate information indicative of an azimuth and an elevation of an optical axis of the passive optical range-finder; and
a communication interface to communicate at least a portion of: the information indicative of a geographic location associated with the passive-optical locator, the information indicative of the distance to the target, and the information indicative of the azimuth and the elevation of the optical axis to a remote device for processing that generates information indicative of an absolute geographic location associated with the target therefrom.

20. The passive-optical locator of claim 19, further comprising;
a global positioning system to generate the information indicative of a geographic location associated with the passive-optical locator.

21. A passive-optical locator, the system comprising:
means for receiving information indicative of a distance to a target from a passive-optical locator;
means for receiving information indicative of an azimuth and an elevation of a direction to the target;
means for receiving information indicative of the geographic location of the passive-optical locator; and
means for generating an absolute geographic location of the target.
